(19) United States
(12) Patent Application Publication
(10) Pub. No.: US 2017/0015462 A1
(43) Pub. Date: Jan. 19, 2017

(54) RESEALABLE CONTAINER WITH DETACHABLE BASE

(71) Applicant: Cool Gear International, LLC, Plymouth, MA (US)

(72) Inventors: Donna Roth, Duxbury, MA (US); Henry Roth, Duxbury, MA (US); John D. Mason, Bridgewater, MA (US)

(73) Assignee: Cool Gear International, LLC, Plymouth, MA (US)

(21) Appl. No.: 15/120,654

(22) PCT Filed: Feb. 23, 2015
(86) PCT No.: PCT/US2015/017128

§ 371 Date: Aug. 22, 2016

Related U.S. Application Data
(60) Provisional application No. 61/943,275, filed on Feb. 21, 2014.

(51) Int. Cl. B65D 8/00; B29C 65/08; B65D 41/06; B65D 41/04; B65D 45/06; B65D 53/02

(52) U.S. Cl. CPC B65D 11/04; B65D 45/06; B65D 53/02; B65D 41/06; B65D 41/0471; B29C 65/08; B29D 22/003

(57) ABSTRACT

A resealable container includes a container top having an opening and a base mating end, a base mating band having a top end and a bottom end; and a detachable base having a top mating end and base bottom. The base mating end of the container top may be afixed to the top end of the base mating band while the bottom end of the base mating band may be configured to detachably mate to the top mating end of the detachable base so as to provide a resealable container with a narrow opening that allows contents of the container to be dispensed in an accurate and controlled manner, while also having a detachable base that provides improved access to the interior of the container to facilitate the ability to fill, clean, or add contents to the resealable container.

### RELATED APPLICATIONS

This application claims the benefit of priority of U.S. Provisional Application No. 61/943,275, filed Feb. 21, 2014, the entire contents of which are hereby incorporated by reference in their entirety.

### BACKGROUND OF THE DISCLOSURE

1. Field of the Disclosure

The present disclosure relates to containers, and more particularly to resealable containers with a detachable base.

2. Description of the Related Art

Containers for fluids (e.g., water, juice, sports drinks, and the like) and solids (e.g., sugar, salt, spices, and the like) are widely used for a variety of purposes such as, for example, storing beverages and foodstuffs. Such containers often have a narrow opening to facilitate the accurate and controlled release of fluids and solids from the container. Unfortunately, narrow container openings make it difficult to access the interior of the container. For example, narrow container openings make it difficult to fill or clean the container. Additionally, narrow container openings make it difficult to add items (e.g., sugar, flavoring, ice, and the like) to the container. Accordingly, there is a need for resealable containers that provide improved access to the interior of the container.

### SUMMARY OF THE DISCLOSURE

The present disclosure relates to containers, and more particularly to resealable containers with a detachable base.

In one aspect, the disclosure provides a resealable container including a container top having an opening and a base mating end, a base mating band having a top end and a bottom end, and a detachable base having a top mating end and base bottom. The base mating end of the container top may be afixed to the top end of the base mating band while the bottom end of the base mating band may be configured to detachably mate to the top mating end of the detachable base so as to provide a resealable container with a narrow opening that allows contents of the container to be dispensed in an accurate and controlled manner, while also having a detachable base that provides improved access to the interior of the container to facilitate the ability to fill, clean, or add contents to the resealable container.

In one embodiment, the disclosure provides a resealable container made of a material selected from the group consisting of plastic, aluminum, stainless steel, and any combination thereof. In a preferred embodiment, the material is a plastic selected from the group consisting of high density polyethylene (HDPE), low density polyethylene (LDPE), polypropylene (PP), and Tritan. In a more preferred embodiment, the plastic is Tritan.

In another embodiment, the disclosure provides a resealable container having a resealable closure mechanism selected from the group consisting of a latch cap, a screw cap, a twist lock cap, and a threaded cap. In a preferred embodiment, the resealable closure mechanism is a latch cap.

In another embodiment, the disclosure provides a base mating band configured to detachably mate to the top mating end of the detachable base by a mating connection selected from the group consisting of a threaded connection, a twist-lock connection, a snap-lock connection, and a friction fit connection. In a preferred embodiment, the base mating band is configured to detachably mate to the top mating end of the detachable base by a threaded mating connection.

In another embodiment, the disclosure provides that the base mating end of the container top is afixed to the top end of the base mating band by mechanical fastening, fusion bonding, hot-gas welding, vibration welding, ultrasonic welding, induction welding, dielectric welding, or solvent bonding. In a preferred embodiment, the base mating end of the container top is afixed to the top end of the base mating band by ultrasonic welding.

It is to be understood that both the foregoing general description and the following detailed description are exemplary and explanatory only and are intended to provide further explanation of the present disclosure, as claimed.

### BRIEF DESCRIPTION OF THE DRAWINGS

The objects, features, and advantages of the present disclosure will be more apparent from the following detailed description in conjunction with the accompanying drawings, in which:

FIG. 1 is an exploded view of a resealable container having a detachable base according to an exemplary embodiment of the disclosure;

FIG. 2 is a front view of a resealable container having a detachable base according to an exemplary embodiment of the disclosure;

FIG. 3 is a side view of a resealable container having a detachable base with an inset depicting an illustrative coupling by which to secure the detachable base to the resealable container according to an exemplary embodiment of the disclosure;

FIG. 4 is a bottom view of a resealable container having a detachable base according to an exemplary embodiment of the disclosure; and

FIG. 5 is a side view of a resealable container having a detachable base with an inset depicting an illustrative coupling by which to secure the detachable base to the resealable container according to another exemplary embodiment of the disclosure.

FIG. 6 is a front view of a resealable container having a detachable base according to another exemplary embodiment of the disclosure.

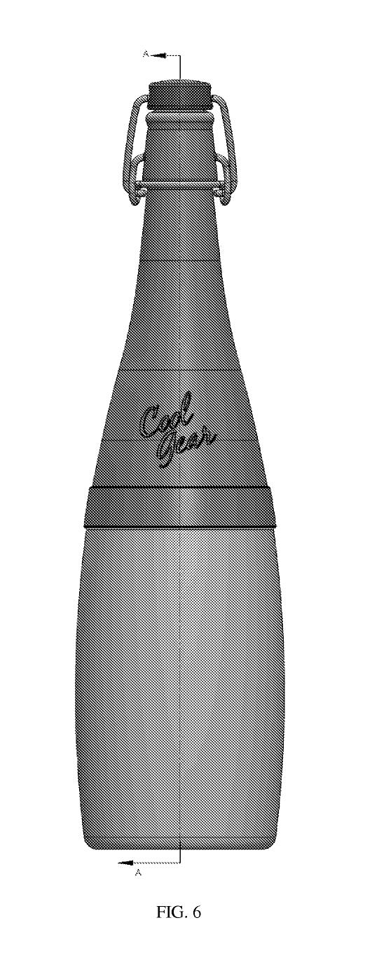

FIG. 7 is a side view cutaway view of a resealable container having a detachable base according to another exemplary embodiment of the disclosure including an inset depicting an illustrative coupling by which to secure the detachable base to the resealable container.

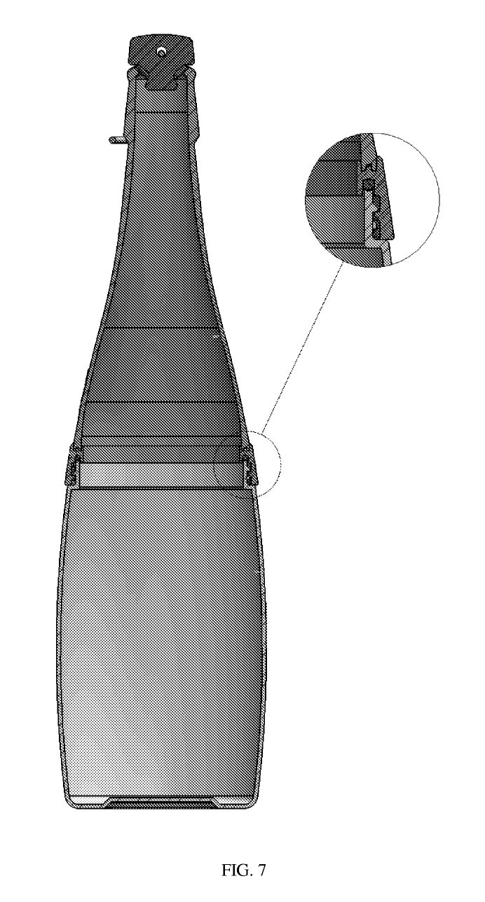

### DETAILED DESCRIPTION OF THE DISCLOSURE

The present disclosure relates to containers, and more particularly to resealable containers with a detachable base. Advantageously, the present disclosure provides a resealable container with a narrow opening that allows contents of the container to be dispensed in an accurate and controlled manner, and a detachable base that provides improved access to the interior of the container to facilitate the ability of a user to fill, clean, or add contents (e.g., sugar, flavoring, ice cubes, etc.) to the resealable container, thereby providing a solution to the longstanding problem presented by containers with narrow openings that make it difficult to access the interior of the container.

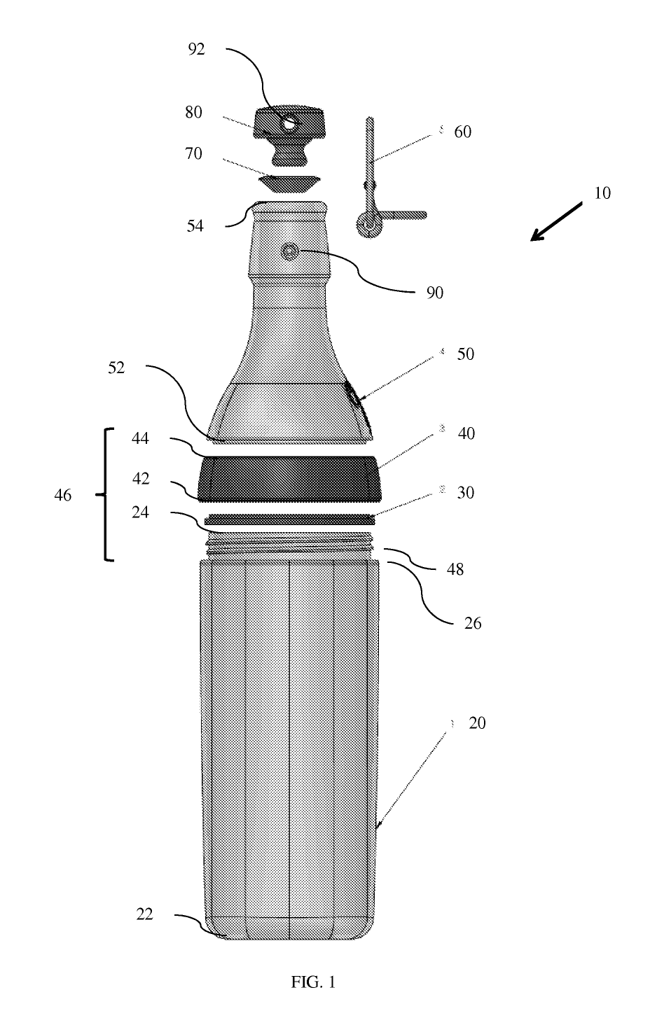

Referring to FIGS. 1-3, resealable container 10 according to the present disclosure includes a detachable base 20, a container gasket 30, a base mating band 40, and a container top 50. Detachable base 20 includes base bottom end 22 and top mating end 24, and container top 50 includes base mating end 52 and opening 54. Detachable base 20 may be configured to be mated to container top 50 via base mating band 40, which includes top bottom end 42 and top end 44, by any of a number of mating connections known in the art (e.g., threaded connection, twist-lock connection, snap-lock connection, friction fit connection, etc.).

FIG. 1 depicts an exploded view of the mating portion 46 of resealable container 10 showing that base mating end 52 of container top 50 may be afixed (e.g., by mechanical fastening, fusion bonding, hot-gas welding, vibration welding, ultrasonic welding, induction welding, dielectric welding, solvent bonding, etc.) to top end 44 of base mating band 40, while bottom end 42 of base mating band 40 may be mated to the top mating end 24 of detachable base 20 by a mating connection, for example, threaded connection 48.

While the exemplary embodiment depicted in FIG. 1 is shown with a mating connection between bottom end 42 of base mating band 40 and top mating end 24 of detachable base 20, it is contemplated within the scope of the disclosure that a mating connection could also be located between base mating end 52 of container top 50 and top end 44 of base mating band 40. In another embodiment, a mating connection could also be located between base mating end 52 of container top 50 and top end 44 of base mating band 40 and also between bottom end 42 of base mating band 40 and top mating end 24 of detachable base 20 so that mating connections could be situated on both sides of base mating band 40. It is further contemplated within the scope of the disclosure that container top 50 may be directly mated to detachable base 20 without the use of base mating band 40. For example, base mating end 52 of container top 50 may be configured with a mating connection (e.g., a threaded connection) for direct mating with detachable base 20.

To ensure a leak proof fit when container top 50 is mated to detachable base 20, container gasket 30 may be sandwiched between bottom end 42 of base mating band 40 and top mating end 24 of detachable base 20. Container gasket 30 may be any appropriate type of gasket (e.g., O-ring gasket, L gasket, etc.) made of any suitable material (e.g., rubber, ethylene propylene diene monomer rubber, natural rubber, neoprene, nitrile (butadiene acrylonirile, BUNA-N), styrene butadiene (SBR, BUNA-S), silicone, natural gum, etc.). The location, type, or number of gasket(s) used to ensure a leak proof fit may be modified to suit the particular mating connection type(s) or configuration(s), used to mate container top 50 to detachable base 20.

In the exemplary embodiment shown in FIG. 1, bottom end 42 of base mating end 40 may be seated on mating lip 26 located proximate to top mating end 24.

Resealable container 10 may further include a resealable closure mechanism having a latch 60, a plug gasket 70, a plug 80, a latch attachment point 90, and a latch bore 92. While the exemplary embodiment depicted in FIG. 1 is shown with a latch type resealable closure (e.g., a latch cap), it is contemplated within the scope of the disclosure that any suitable resealable closure mechanism may be used such as, for example, a screw cap, a twist lock cap, a threaded cap, etc.

Resealable container 10 may be made of any desirable material suitable for the intended purpose of resealable container 10 such as plastic, aluminum, stainless steel, etc. In preferred embodiments, resealable container 10 may be made of plastic (e.g., high density polyethylene (HDPE), low density polyethylene (LDPE), polypropylene (PP), Tritan, etc.).

Resealable container 10 may be sized to fit the desired application. For example, resealable container 10 may range in size from 4 ounces to 512 ounces, or larger if desired. In a preferred embodiment, resealable container 10 may range in size from 4 ounces to 128 ounces. In a more preferred embodiment, resealable container 10 may 8, 12, 20, 24, or 36 ounces in size.

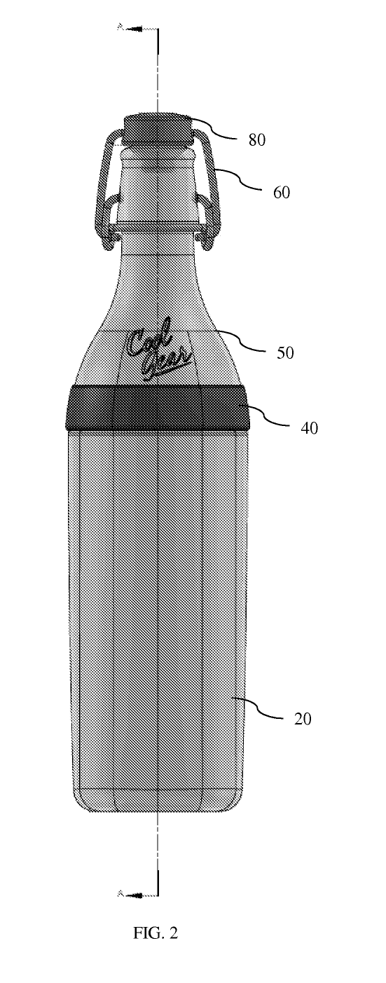

FIG. 2 depicts a front view of resealable container 10 with container top 50 mated to detachable base 20.

While the exemplary embodiment shown in FIGS. 1-2 depicts the relative location of mating portion 46 at a position approximately two-thirds from base bottom 22 of resealable container 10, it is contemplated within the scope of the disclosure that the position of mating portion 46 may be varied relative to base bottom 22 to suit the desired application for resealable container 10.

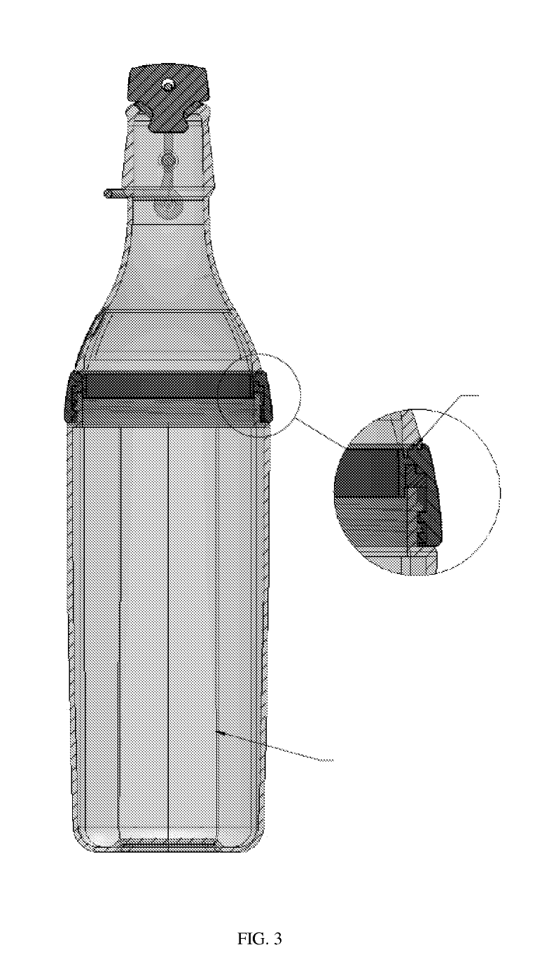

FIG. 3 depicts a cutaway section of an exemplary embodiment of resealable container 10 with an inset showing details of mating portion 46, including ultrasonic weld 100 and container gasket 30, where container gasket 30 is an L type gasket.

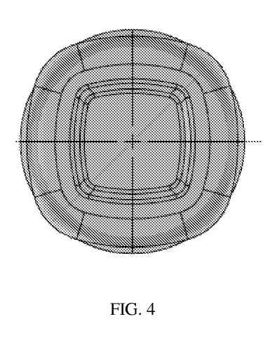

FIG. 4 depicts a bottom view of resealable container 10.

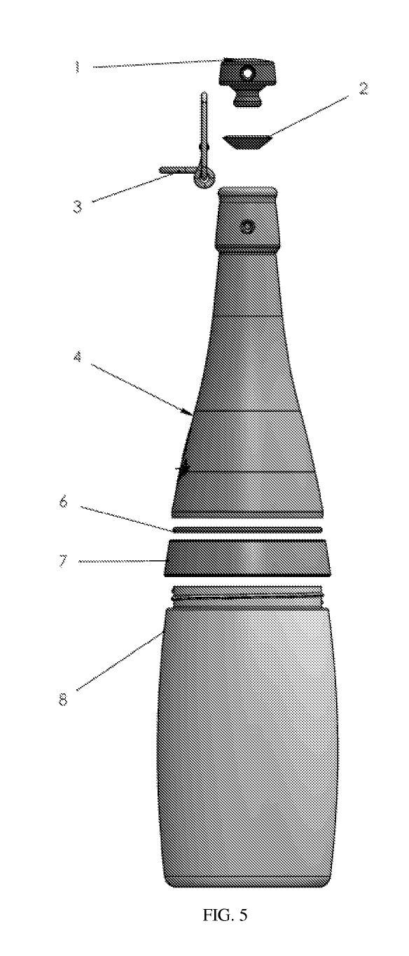

FIG. 5 depicts another embodiment of resealable container 10 having an alternate shape with an inset showing details of mating portion 46, including ultrasonic weld 100 and container gasket 30, where container gasket 30 is an O-ring type gasket.

The foregoing description of preferred embodiments of the present disclosure has been presented for the purposes of illustration and description. It is not intended to be exhaustive or to limit the disclosure to the precise form disclosed. Modifications and variations are possible in light of the above teachings, or may be acquired from practice of the disclosure. The embodiments were chosen and described in order to explain the principles of the disclosure and its practical application to enable one skilled in the art to utilize the disclosure in various embodiments and with various modifications as are suited to the particular use contemplated. It is intended that the scope of the disclosure be defined by the claims appended hereto, and their equivalents.

What is claimed is:

1. A resealable container, comprising:
a container top having an opening and a base mating end;
a base mating band having a top end and a bottom end; and
a detachable base having a top mating end and base bottom,
wherein the base mating end of the container top is afixed to the top end of the base mating band and the bottom end of the base mating band is configured to detachably mate to the top mating end of the detachable base.

2. The resealable container of claim 1, wherein the resealable container is made of a material selected from the group consisting of plastic, aluminum, stainless steel, and any combination thereof.

3. The resealable container of claim 2, wherein the plastic is selected from the group consisting of high density polyethylene (HDPE), low density polyethylene (LDPE), polypropylene (PP), and Tritan.

4. The resealable container of claim 1, further comprising a resealable closure mechanism.

5. The resealable container of claim 4, wherein the resealable closure mechanism is selected from the group consisting of a latch cap, a screw cap, a twist lock cap, and a threaded cap.

6. The resealable container of claim 1, wherein the base mating band is configured to detachably mate to the top mating end of the detachable base by a mating connection selected from the group consisting of a threaded connection, a twist-lock connection, a snap-lock connection, and a friction fit connection.

7. The resealable container of claim 1, wherein the base mating band is configured to detachably mate to the top mating end of the detachable base by a threaded mating connection.

8. The resealable container of claim 1, wherein the base mating end of the container top is afixed to the top end of the base mating band by mechanical fastening, fusion bonding, hot-gas welding, vibration welding, ultrasonic welding, induction welding, dielectric welding, or solvent bonding.

9. The resealable container of claim 1, wherein the base mating end of the container top is afixed to the top end of the base mating band by ultrasonic welding.
